(19) United States
(12) Patent Application Publication
(10) Pub. No.: US 2025/0237355 A1
(43) Pub. Date: Jul. 24, 2025

(54) Dispensing System for Filling and Refilling Propane Containers

(71) Applicants: Michael Foley, Winlock, WA (US); Charles Wood, Toledo, WA (US); Martti Lemieux, Echo Bay (CA); Tony Peterson, Woodland, WA (US); Randy Hanson, Onalaska, WA (US); Caleb Vainikka, Waconia, MN (US)

(72) Inventors: Michael Foley, Winlock, WA (US); Charles Wood, Toledo, WA (US); Martti Lemieux, Echo Bay (CA); Tony Peterson, Woodland, WA (US); Randy Hanson, Onalaska, WA (US); Caleb Vainikka, Waconia, MN (US)

(21) Appl. No.: 18/986,114

(22) Filed: Dec. 18, 2024

Related U.S. Application Data
(60) Provisional application No. 63/611,744, filed on Dec. 18, 2023.

(51) Int. Cl. F17C 5/00; F17C 5/06; G06Q 20/38

(52) U.S. Cl. CPC F17C 5/005; F17C 5/06; G06Q 20/38; F17C 2221/035; F17C 2270/059

(57) ABSTRACT

A dispensing system for filling and refilling user propane tanks comprised of a point of purchase payment system with interactive display. Each purchased propane tank is filled at an access point within the dispensing unit for users to retrieve their order. A secondary payment method involves the use of a mobile app to purchase propane tanks and propane. A docking area takes both new tanks and tanks that need refilling. When refilling a propane tank, the user inserts the propane tank into the docking area. The propane tank is mechanically filled and inspected with cameras for damage and a leak test is conducted returned to the original docking area for the user to retrieve. The final amount on the customer invoice is based on the actual quantity of propane delivered into the user tank. The system also includes an autofill nozzle and autofill valve for application such as RVs.

### BACKGROUND

Today's propane industry suffers from an outdated infrastructure and supply chain that costs the industry extensive amounts both in terms of human capital as well as financial costs. The industry admits it needs to focus on innovation as it suffers from low customer satisfaction. The current supply chain for propane is a status quo, legacy system that has yet to adopt an intelligently connected, data driven automation, within an end-to-end ecosystem. As a result, human error results in accidents, delays in service, and premium insurance costs plaque the industry.

On the delivery side of the equation, large regional distribution fill centers require human capital and complex logistics to operate. These fill centers are semi-automated and require employees to physically manipulate each user propane tank a within the unloading, refilling, and redeploying stages of user propane tank refilling.

Propane is a strategic energy source for the United States and is heavily used within military, industrial and commercial applications. Throughout the past decade a number of accidents have resulted in both injury and death, increasing insurance rates while at times putting additional strain on the supply of propane.

On the consumer side, we see retail locations challenged with accommodating customers by scheduling employees to cover filling of user propane tanks during normal business hours. Using untrained employees to fill user propane tanks means customers wait or are forced to purchase from other locations. And even when employees are trained, improper visual assessment of tanks and improper filling have led to deadly accidents.

The main problems of the current system are:

No automated filling capability at user interface locations, a person is required to fill the user propane tanks, and that person has many other duties. The other option is to send empty user propane tanks back to a central filling location which increases cost.

There is not an easy purchasing process for users, the user propane tanks are in a secure area of a current distribution site, the user must enter a store or other facility, purchase a filled user tank, either leaving their user tank behind or arranging to find someone to fill their tank. The purchase process of the current system may take 15 plus minutes and is very inconvenient.

### SUMMARY OF THE INVENTION

### Overall Summary

A dispensing system for filling and refilling user propane tanks comprised of a point of purchase payment system with interactive display. A user swipes or taps a credit or debit card to access the purchasing options, then selects the desired tank size, amount of tanks they intend to purchase, and confirms order. Each purchased propane tank is then filled and an access point within the dispensing unit for users to retrieve their order.

A secondary payment method involves the use of a mobile app to purchase propane tanks and propane. Once payment has been made using the mobile app, a code is generated and entered at the dispensing site. After the code is entered, either a new tank is filled or the tank placed inside the dispensing site for refilling is initiated.

When refilling a propane tank, the user inserts the propane tank into the docking area. The propane tank is mechanically engaged once the access door has been closed and locked. Each propane tank is identified by an embedded RFID tag within the propane tank handle, allowing for a specific propane tank history to be created and matched to tanks. The propane tank is mechanically moved to a propane filling area where the propane tank is weighed, visually inspected with cameras for damage and a leak test is conducted to ensure propane tank has not been damaged before propane filling is initiated. The full propane tank is then mechanically returned to the original docking area for the user to retrieve.

For refilling using the app, a code is sent to the user's mobile device after a propane tank is purchased. The code is entered by the user at the main user interface screen, the access door is then unlocked allowing the user to open door and place the propane tank into the docking area. The door is mechanically locked once the door has been closed. A filling procedure that only requires a user insert the user propane tank into a access area or starting point of a user propane tank moving apparatus, and then pick-up the propane tank from the same access area to remove the propane tank.

The final amount on the customer invoice is based on the actual quantity of propane delivered into the user tank rather than a standard fee for refilling a user tank. The system also includes an autofill nozzle, autofill valve for application such as RVs, where placing propane tanks into the automated system is not practical

Listed next is a sequence of steps for the method and system.

### Purchasing at Point of Sale

Customer would use a payment method such as a credit card or debit card to proceed with new propane tank purchase or propane tank refilling. Once a payment method has been accepted the customer either select new tank and proceeds to select the tank size and number of tanks to purchase, or inputs refill current tank and proceeds to select the tank size and number of tanks to refill. The customer is presented with the total dollar amount of the purchase, when the customer confirms the purchase, the propane dispensing system mechanically acquires tanks from within its internal inventory to begin filling the purchased propane tanks. As each propane tank is filled it is mechanically moved to the access area to be retrieved by the customer before another tank is filled.

When a customer is refilling a propane tank, a payment method such as a credit card or debit card is used. After the payment method is accepted the customer selects the refill option on the user interface display. The access door is unlocked allowing the customer to place the propane tank inside the access door for filling. The door is mechanically locked once closed and propane tank refilling is initiated. The propane tank is mechanically moved to the access area after filling is complete to be retrieved by the customer.

### Setting up an Account using the App

Customer would download an app, create an account, adding a login, password, two-step authentication and payment information. The app allows customers to purchase multiple user propane tanks and user propane tank sizes.

Customer must purchase propane as well as a propane user tank after filling, with a new tank, or just the propane in the case of a user supplied propane tank. When a user propane tank is filled, a confirmation code is emailed or texted to customer. These steps may also be completed at a card reader site at a dispensing location. All user propane tanks have an RFID # for identification to ensure that the user propane tank manufactured works specifically with the propane dispensing system and is properly filled by the dispenser. Information regarding the propane tank condition and propane fill amount is recorded and stored.

### Setting Up Dispensing System at Dispensing Locations

Install propane storage and dispensing tanks with standard filling and dispensing apparatus at dispensing location. Propane dispensing tank needs to be able to measure the actual propane dispensed and communicated that to a billing location, which could be a central system, or a local based system at a card reader.

Install a storage location for multiple new user propane tanks with a payment method for purchasing user propane tanks. Devices needed: credit card reader, optional, have a code entry system, and a secure storage device that will release one tank at a time.

Install a payment system for refilling user propane tanks, payment system can be in a wide variety of ways such as a) users arrive at a fill station and use the built in display to purchase, b) Users purchase a user tank online (fullhugo.com, Amazon, etc.) or at a retail location (think Cabela's, Walmart, REI . . . go to fill station to fill the user propane tank, c) users Download the app, purchase tank+propane with a credit card, received a code, show up to fill location, enters the code, and receive their user propane tank.

Have an access door to open to place the user propane tank into the system.

Have a user propane tank placement apparatus, for placing the user propane tank prior to filling, either a new propane user tank, or a previously used user propane user tank may be placed in the apparatus. In the preferred embodiment the drawer slide operates as both the user tank placement apparatus and user propane tank moving system.

Have the user propane tank placement apparatus be a part of a user propane tank moving system that will position the user propane tank for filling and then after filling move the user propane tank to an exit point.

This user propane tank filling apparatus may in another embodiment be for filling a single user propane tank, so the user would simply put the user propane tank into a fixed placement apparatus inside the door, close the door and push the start button.

Automatic filling of the propane from the dispensing tank, with a dispenser apparatus that that automatically connects to the user propane tank.

In cases where it is not practical to insert user propane tank into the automated system, such as with some RV applications, an autofill nozzle, autofill valve are also available

Install a control system, which may be one or more controllers, the control system consisting of a start button, a sensor device that notifies the dispenser that the user propane tank is in the proper position, activates the user propane tank device filling procedure, measures the amount of propane dispensed, disconnects the user propane tank dispenser system, activates the user propane tank movement system to move the user propane tank to the exit position, which once the user propane tank reaches that position activates an signal for the user to take the user propane tank away, and the control system then calculates a billing amount, prepares an invoice and sends it to the card reader or a central payment processing site.

### Condensed View of System

The automated propane filling station comprised of the main enclosure, internal structure, hub-less carousel, robotic user tank picker, user tank drawer slide, autofill nozzle, autofill valve, fill area for 20 lbs & 30 lbs tanks, fill area for 16 oz tank, RV fill area from the dispensing tank, user tank RFID, display screen, doors, distribution tank, payment method, website, mobile app.

When the above areas work in concert with each other, customer will download the app, create an account, adding a login, password, two-step authentication and payment information. The app allows customers to purchase multiple user propane tanks and user tank sizes. Customer must purchase propane as well as user propane tank. When a purchase is made, a confirmation code is emailed or text to customer.

### BRIEF DESCRIPTION OF DRAWING

FIG. 1 shows the overall view of the dispensing station.

FIG. 2 is a front view of the station.

FIG. 3 is a back view of the station.

FIG. 4 is a view of the left (when looking at the front) view of the station.

FIG. 5 shows the right (when looking at the front) view of the station.

FIG. 6 shows a simplified side view of the dispensing station.

FIG. 7 shows the outer frame and cross bars and carousel rotation rails.

FIG. 8 shows user propane tank base moving into tank recessed docking area and the door slide that will take it into the station.

FIG. 9 shows the user propane tank after it has been moved into the station.

FIG. 10 shows the user propane tank as it is about to be set into the tank recess docking area.

FIG. 11 shows the user propane tank base fully docked into tank recess docking area of the carousel.

FIG. 12 and FIG. 13 shows an embodiment where the propane tank is filled at the access door.

FIG. 12 shows through the access door a propane tank waiting to be refilled.

FIG. 13 showcases the propane autofill moving downward to in a engage and fill propane tanks.

FIG. 14 shows the small access door for filling 16 ounce tanks.

FIG. 15 shows the 16 ounce tank being auto filled.

FIG. 16 shows the robotic picker retrieving new 20 lbs and 30 lbs tanks from the carousel, and three (could also be four) vertical arms compressing around the body of the propane tanks.

FIG. 17 shows the carousel levels and the open pass-through slot of the propane fill station. Each carousel has eleven open slots.

FIG. 18 shows a top view of carousel and the eleven open slots as well as the open pass-through slot.

FIG. 19 shows the access code being delivered to a user's cell phone.

FIG. 20 shows the user entering the access number on the dispensing station.

FIG. 21 shows the cell phone display to select a tank to be filled and confirming purchase.

FIG. 22 shows the user opening the access door, and how the tank to be filled is attached to the door.

FIG. 23 shows how the RFID is attached to the tank.

FIG. 24 shows the vertical path the robot picker takes to deliver to and pick up user propane tanks at the delivery door.

FIG. 25 shows a sequence of actions for delivering a tank to a carousel level.

FIG. 26 shows an alternative embodiment, a gravity fed storage system.

FIG. 27 shows the alternate embodiment, a gravity fed storage system with both 16 oz. and 20 or 30 lb. tanks.

FIG. 28 shows horizontally stored tanks are shifted into the upright position as they come down a gravity fed ramp.

FIG. 29 Show the exit point of a gravity fed system delivering user propane tanks to the user.

FIG. 30 shows how both 20 and 30 pound tanks as well as 16 ounce tanks can be in the gravity fed system.

FIG. 31 shows how the robot picker can be reconfigured for horizontal tanks.

FIG. 32 shows the carousel empty of user propane tanks.

FIG. 34 shows the carousel full of user propane tanks.

FIG. 34 shows the location and devices that allow the carouse levels to turn.

FIG. 35 show a user using a autofill propane tank dispensing system with a retail system for purchasing new tanks.

FIG. 36 Shows an autofill station from a dispensing tank for users to refill their tanks.

FIG. 37 shows three sizes of propane tanks, 10 pound, 20 pound and 30 pound.

FIG. 38 shows how an airflow system can be introduced to the housing to remove propane gas.

FIG. 39 shows an alternative embodiment, a pivoting tank holder with open arms to move tanks in and out of the housing.

FIG. 40 is a storage and dispensing 16 oz. tank system.

FIG. 41 is retail storage for 20 lb. or 30 lb. user propane tanks.

FIG. 42 is a retail setting for the housing and system, everything is within a building.

FIG. 43 shows the housing and dispensing system inside of a building.

FIG. 44 shows an opening screen where the customer is paying on-site.

FIG. 45 shows how the customer selects what size tank they want.

FIG. 46 shows the customer using the access door to inset the user propane tank for filling

FIG. 47 shows the autofill dispensing nozzle, which is connected to the fill line (not shown) prior to being inserted into the autofill valve.

FIG. 48 shows the autofill dispensing nozzle starting to be inserted into the autofill valve.

FIG. 49 shows the autofill nozzle fully inserted, but still with a section abode the autofill valve, and the part that opens the flow to the user propane tank depresses and connected to the user propane tank's autofill valve.

FIG. 50 to FIG. 51 shows an alternative configuration where the autofill nozzle is inserted completely into the autofill valve.

FIG. 52 shows the coupling connection to the user propane tank.

### EXPLANATION OF NUMBERS ON DRAWINGS

1. Main enclosure of the dispensing system for filling and refilling propane containers.
2. Dispensing tank.
3. Dispensing tank fill area.
4. Dispensing fill line.
5. Dispensing line out.
6. RV fill system.
7. Display.
8. 16 oz. fill area.
9. Drawer slide.
10. Main fill area preferred embodiment.
11. Carousel levels.
12. Robotic picker.
13. 16 oz. user propane tanks.
14. 20 or 30 lb. user propane tanks.
15. Access door to the propane fill station consisting of an opaque plastic bezel.
16. Outer frame of the propane fill station.
17. Inner frame of the propane fill station.
18. Carousel rotation rails.
19. Cross arms connecting outer frame and inner frame.
20. Open pass through slots.
21. Open slots for tanks.
22. Position of user propane tank when place in door slide.
23. Position of Propane tank when moved into slot for the robot picker.
24. User propane tank base moving into tank recessed docking area.
25. Tank recess docking area.
26. Access door.
27. Transparent inner Plexiglas window.
38. Concealed door handle.
29. Auto fill door.
30. Propane autofill nozzle.
31. Small access door to 16 oz. filling area.
32. Transparent inner Plexiglas window 16 oz. filling area.
33. Concealed door handle to small 16 oz. filling area.
34. Inner chamfer area to align 16 oz tanks during auto filling.
35. 16 oz. tank holder.
36. Vertical shaft that moves the loaded 16 oz. user propane tanks into autofill area for filling.
37. Three vertical arms around the robot picker.
38. The single vertical path the robot picker follows.
39. The carousel without any user propane tanks place in it.
40. The carousel full of user propane tanks.
41. Five digit access code.
42. Customer entering code on display.
43. RFID code.
44. Alternative to the carousel, 10 lb. user propane tanks gravity fed exit for user propane tanks.
45. Gap between outer edge of carousel and outer diameter of dispensing tank.
47. Upper fixture on carousel level with castors.
48. Lower fixture on carousel level with castors.
49. Gears along outer edge of carousel that interact with direct drive motor to rotate carousel.
50. Inner lower ridge that provides contact area for rail castors.
51. T connector to serve new user tanks filled with the autofill feature.
52. Optional user propane tank storage and dispenser.
53. Propane 10 lb. user tank.
54. Propane 20 lb. user tank.
55. Propane 30 lb. user tank.
56. Built in air flow to remove propane gas (optional).
57. Pivoting user propane tank holder with open arms.
58. Storage system for 16 oz. user propane tanks.
59. Chute that delivers 16 oz. user tank.
60. 16 ounce tank carrier plus 16 oz. user tank.
61. 16 oz. user tank carrier.
63. 20 and 30 lb. user propane tanks storage and dispensing.
64. Access door user propane tank holder.
65. User propane tank autofill valve.
66. Autofill dispensing nozzle.
67. Autofill valve.
68. Autofill valve's part that opens the flow into the user propane tanks filling valve.
69. Coupling regulator to the user propane tank.
70. Coupling connection to the pressure regulator.
71. Gravity fed storage system.
72. Gravity ramp.
73. Holder for 20 lb. and 30 lb. user propane tanks on a pivoting system.
74. Gravity fed storage rack for 20 and 30 lb. user propane tanks and 16 oz. user propane ounce tanks.
75. Ramp for converting horizontal tanks to vertical tanks.
76. Alternative to the carousel, 20 lb. and 30 lb. gravity fed exit for user propane tanks.
77. Horizontal robot picker.
78. A retail station.
79. Storage tank.
80. Propane transfer line from the storage tank to the dispensing tank.

### DETAILED DESCRIPTION

Note: While the preferred embodiment is shown here, it should be noted that the system description listed in the Summary of the Invention can use other components and configurations to achieve a successful operating system meeting the specification within the Summary of the Invention.

FIG. 1 is a view of the system housing as it will appear to users. 1 is the main enclosure, 3 is the port that propane comes in from the main storage tank, 7 is the display the users interact with, 5 is the dispensing line and nozzle to connect with the tanks, 6 is the dispensing line and nozzle for RV's and 14 is a 20 lb. user propane tank.

FIG. 2 is a front view of the dispensing housing, FIG. 3 is the back view, FIG. 4 is the left side view (from a user facing the front) and FIG. 5 is a back view.

FIG. 6 shows a simplified side view of the propane fill station, the fill station is comprised of a main enclosure 1, distribution tank 2 which is filled through the distribution tank fill area 3. Propane travels through distribution fill line 4. Dispensing line-out 5 delivers propane from distribution tank to the RV fill area 6, main fill area 7, and 16 oz fill area 8. The drawer slide 9 travels along a horizontal axis, moving 20 lbs and 30 lbs tanks to where the robotic picker can pick them up or to main fill area 10. Carousels 11 are positioned and rotate around the elongated section of the distribution tank; carousels store 20 lbs and 30 lbs propane tanks 14. A robotic picker 12 moves along a vertical axis capturing propane tanks 4 to place them in carousel slots and or deliver into the drawer slide 7 for filling and distributing to customers upon purchase. 16 oz propane tanks 13 are positioned within the 16 oz fill area 8 to fill tanks. The RV fill area 6 has fill nozzle interface to fill RV's and motorhomes. A display screen 7 showcases customer order, and its fill status, and to allow customers to enter the right size tank

FIG. 7 shows the carousel levels 11 and the open pass-through slots 20 in the carousel levels 11. Each carousel has Eleven Open Slots 21 to receive either a 20 lb. or 30 lb. propane tank 14. Carousels levels rotate left and right, there is no physical hub or center axis.

FIG. 8 and FIG. 9 shows how the drawer slide 9, travels along a horizontal axis moving from position 22 to position 23, moving propane tanks into the open pass-through slot of the carousel. Each carousel level has Eleven Open Slots 21 to receive either a 20 lb. or 30 lb. propane tank 14. Carousels rotate left and right, there is no physical hub or center axis.

FIG. 10 shows the base of the user propane tank 24 about to go into the tank recessed docking area 25.

FIG. 11 shows the base of the user propane tanks 24 inserted into the tank recessed docking area 25.

FIG. 12 shows the Access Door 26 consists of an opaque plastic bezel surrounding a transparent inner Plexiglas 27 window to showcase the propane fill area. To open the access door there is a concealed door handle 28 in the upper right-hand corner of the access door. Within the propane fill area, the autofill door 29 opens upward.

FIG. 13, showcases the Propane Autofill 30 moving downward to engage and fill propane tanks.

FIG. 14 shows the Small Access Door 31 for 16 ounce user propane tanks consisting of an opaque plastic bezel surrounding a transparent inner Plexiglas window to the small 16 ounce propane tank fill 32 to showcase the propane fill area. To open the small access door there is a concealed door handle 33 in the upper right-hand corner. Within the small propane fill area, the roof has inner chamfer area 34 to align 16 oz tanks during auto filling. A 16 oz. tank is loaded into the Holder 35.

FIG. 15 show that when the small access door 31 is shut, it automatically locks before autofill is initiated. A vertical shaft 36 moves the loaded 16 oz propane tanks into autofill area for filling.

FIG. 16 The Robotic Picker 12 retrieves new 20 lbs and 30 lbs user propane tanks 14 from the carousel, three or four vertical arms 37 compress around the body of the propane tanks. The Robotic Picker 12 loads tanks onto the drawer slider 9 for propane filling. Robotic picker travels along a single vertical plane 38.

FIG. 17 shows the carousels 11 and the open pass-through slots 20 of the propane fill station. Each carousel has eleven open slots 21 to receive either a 20 lbs or 30 lbs propane tank. Carousels rotate left and right, there is no physical hub or center axis.

FIG. 18 shows a top view of carousel 11 and the Eleven Open Slots 21 as well as the open pass-through slot 20.

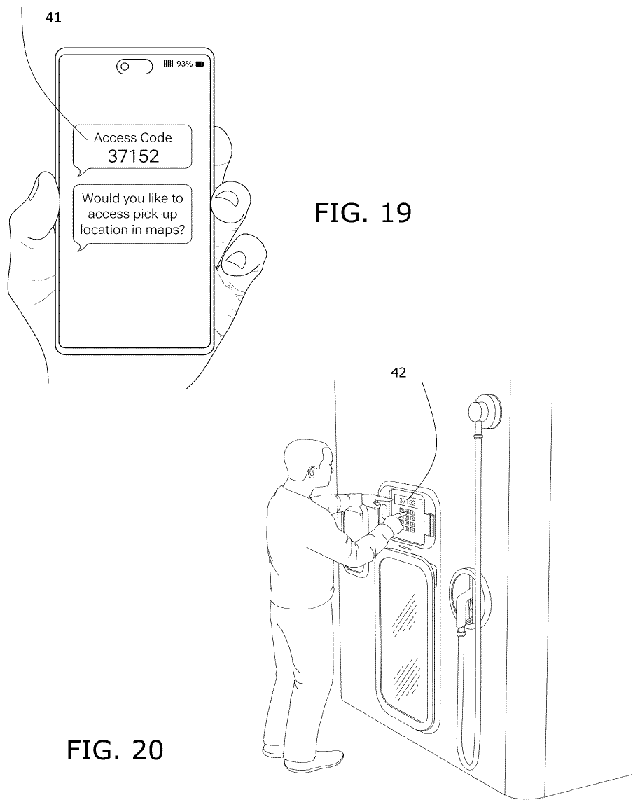

FIG. 19 shows a randomized 5-digit access code 41 that is sent to customers once they have purchased a user propane tank.

FIG. 20 shows customer entering access code 42 on display to retrieve the purchased user propane tank.

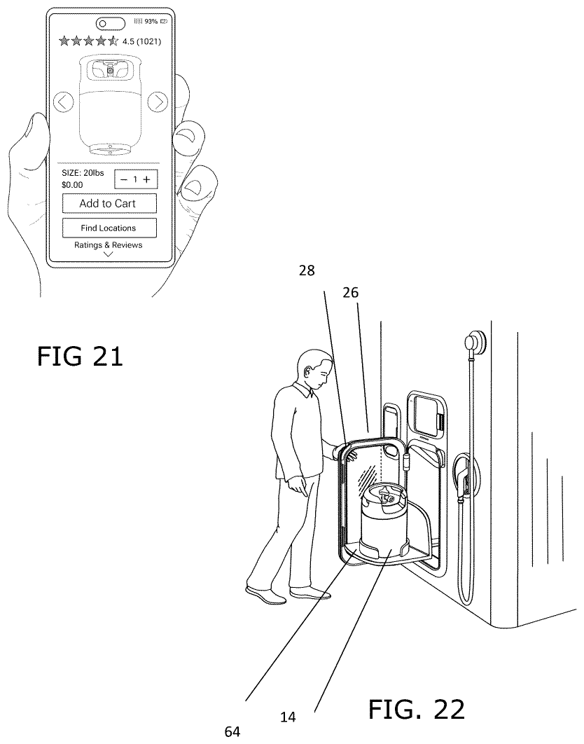

FIG. 21 shows the cell phone display to select a tank to be filled and confirming purchase.

FIG. 22 shows the user opening the access door 26, with the concealed handle 28 and how the tank 14 to be filled is attached to the door 64.

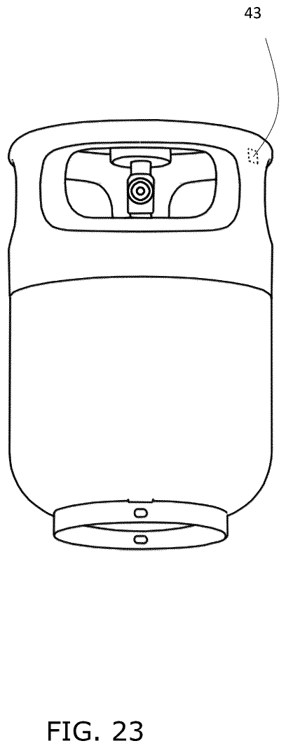

FIG. 23 shows how the RFID 43 is attached to the tank.

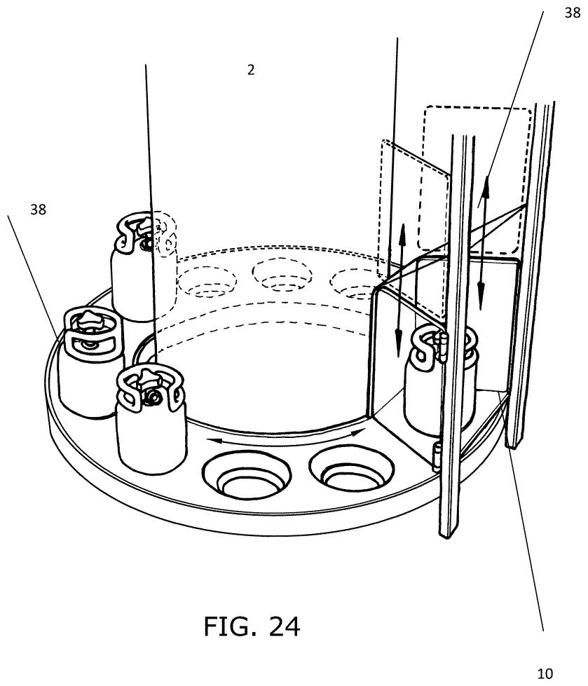

FIG. 24 shows the dispensing tank 2 and the vertical path 38 the robot picker takes to deliver to and pick up user propane tanks 14 on the main fill area 10.

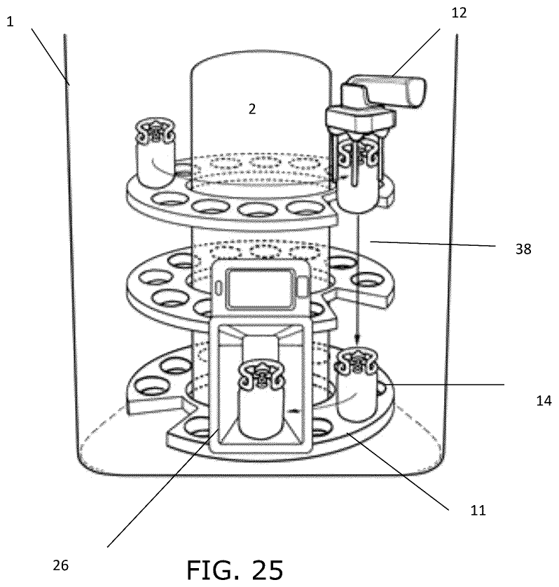

FIG. 25 shows a sequence of actions for delivering a tank to the access door 26, the drawing has the main enclosure 1, the dispensing tank 2, the carousel level 11 where the tank is deposited by the robot picker 12 before the tank is rotated on the carousel 11 to the access door.

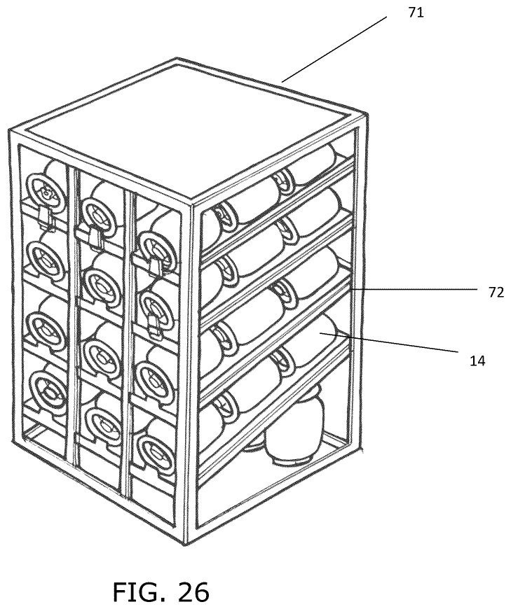

FIG. 26 shows an alternative embodiment, a gravity fed storage system 70, with gravity ramps 72 for 20 and 30 pound tanks 14.

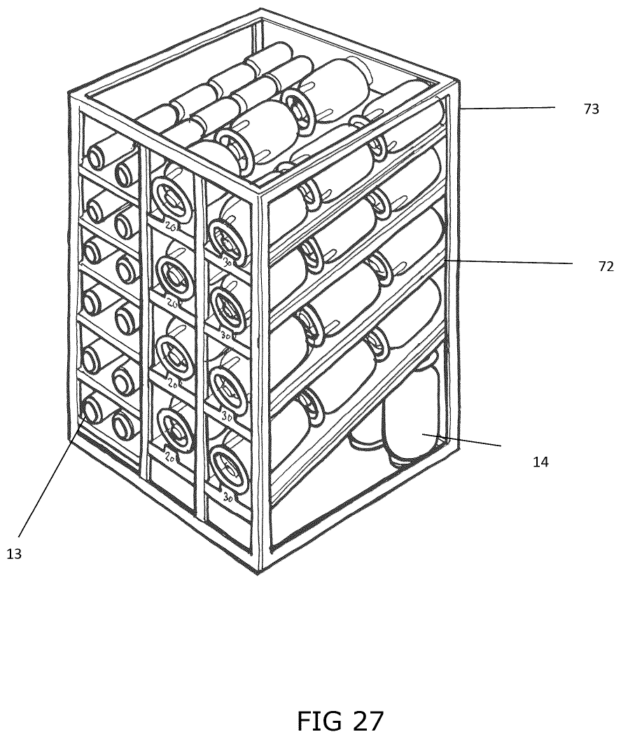

FIG. 27 shows the alternate embodiment, a gravity fed storage system 72 with gravity fed ramps 73 with both 16 ounce 13 and 20 or 30 pound user propane tanks 14.

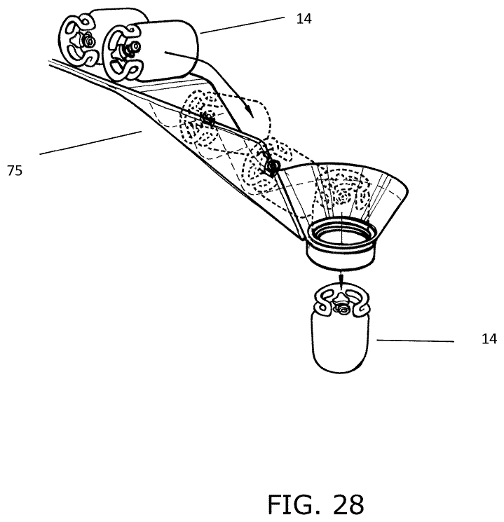

FIG. 28 shows horizontally stored tanks are shifted into the upright position as they come down a gravity fed ramp 75 for converting horizontal tanks to vertical 20pound and 30 pound tanks 14.

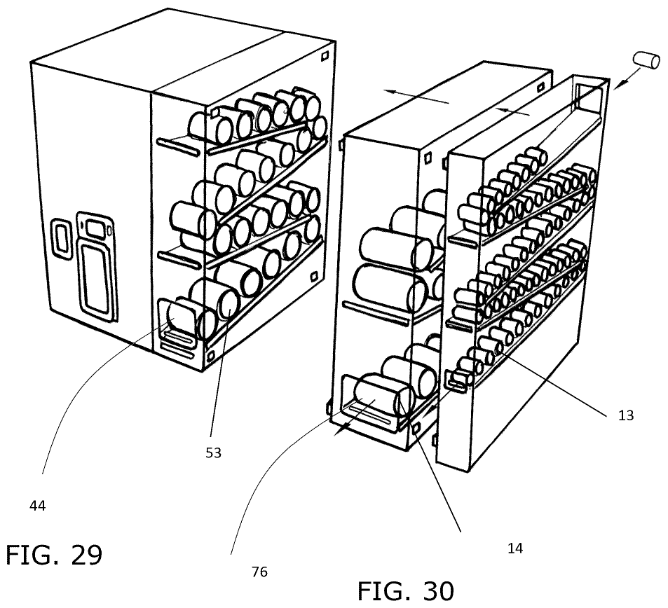

FIG. 29 Show the exit point 44 of a gravity fed system delivering 10 pound user propane tanks 53 to the user.

FIG. 30 shows how 20 and 30 lb. tanks 14 as well as 16 oz. tanks, 13 and the exit point 76 for 20 pound and 30 pound tanks 14 can be in the gravity fed system.

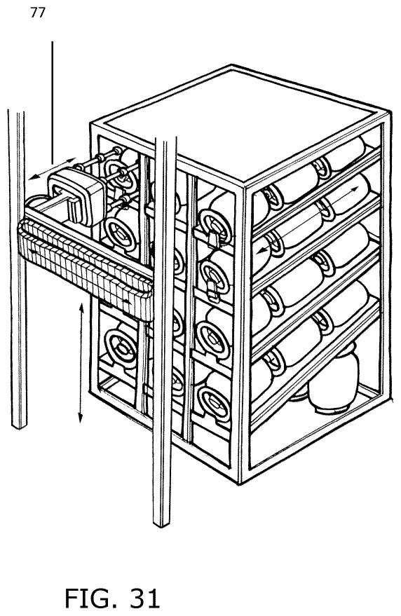

FIG. 31 shows how the robot picker can be reconfigured 77 for horizontal tanks.

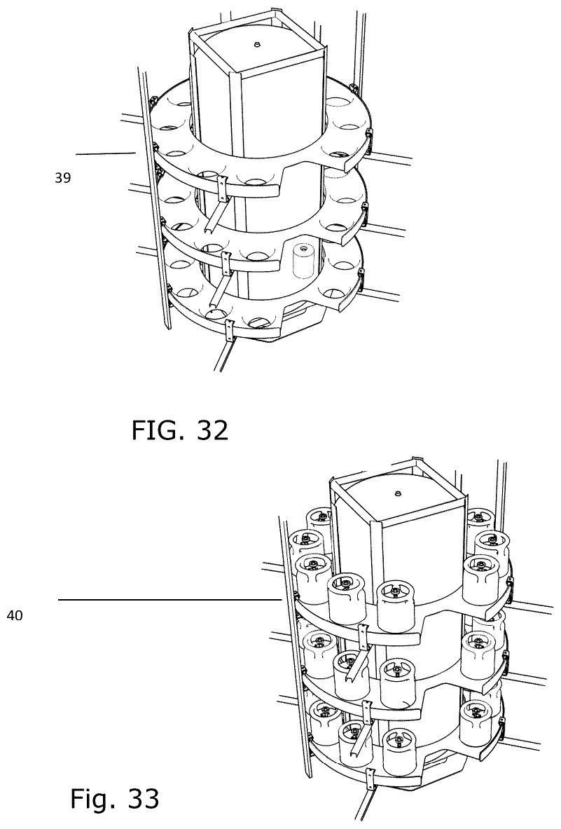

FIG. 32 shows the carousel empty 39 of user propane tanks.

FIG. 33 shows the carousel full 40 of user propane tanks.

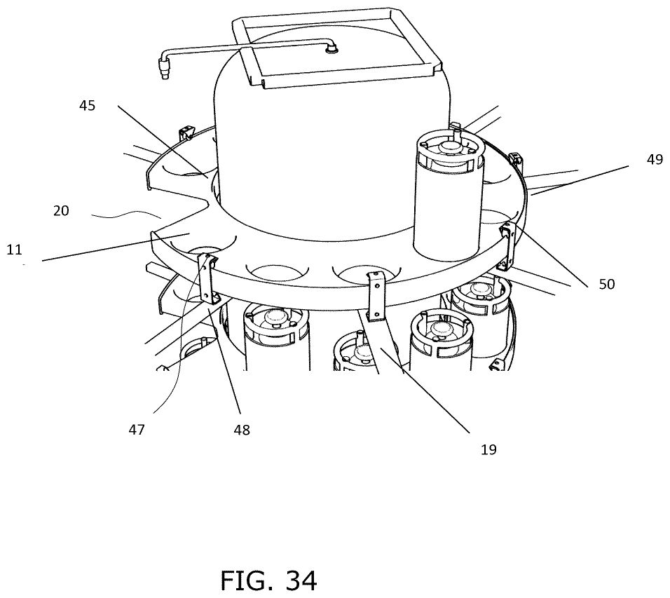

FIG. 34 shows the location and devices that allow the carouse levels to turn. First there is a gap 45 between outer edge of carousel and outer diameter of dispensing tank. There is an upper fixture 67 on carousel level with castors and a lower fixture 48 on carousel level with castors. These fixtures are on the top and bottom of the carousel level 11. The open slot 20 on the carousel level and the cross bars 19 of structural frame are also shown. The outer edge of the carousel level 49 with mechanisms (standard mechanisms such as gears and motors) that turn the carousel 11.

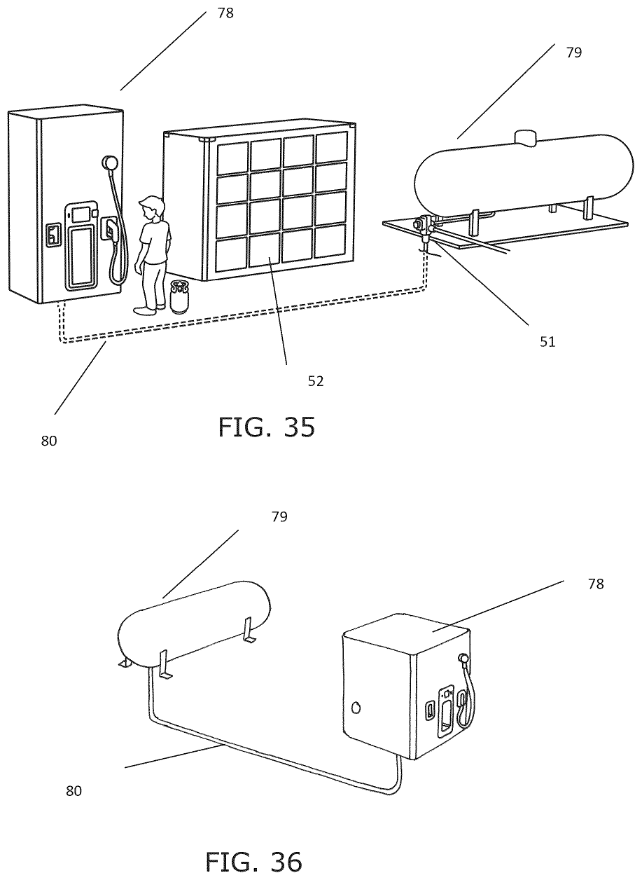

FIG. 35 show a user using an autofill propane tank dispensing system with a retail system for purchasing new tanks, the system has a storage facility for new tanks 52 and it shows the T connection 51 from the main storage tank to the retail station.

FIG. 36 Shows an autofill retail station 78 getting propane from a storage tank 79 from a dispensing tank for users to refill their tanks A T connection 51 from the storage tank through a fill line delivers the propane. Also on sight is a storage facility 52 for user propane tanks

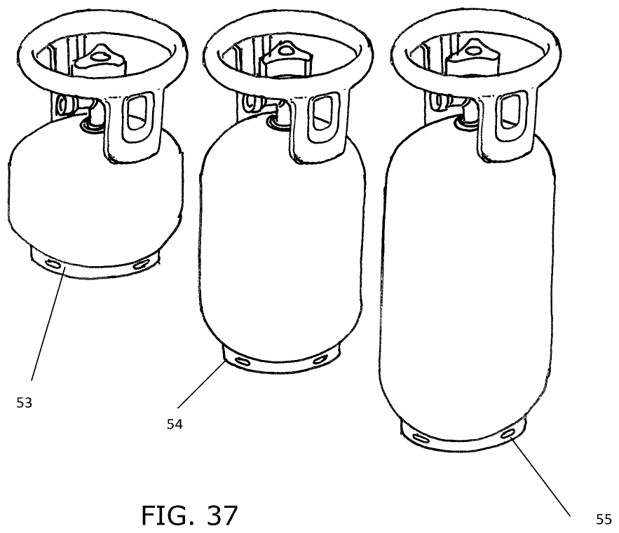

FIG. 37 shows three sizes of propane tanks, 10 lb. 53, 20 lb. 54 and 30 lb. 55.

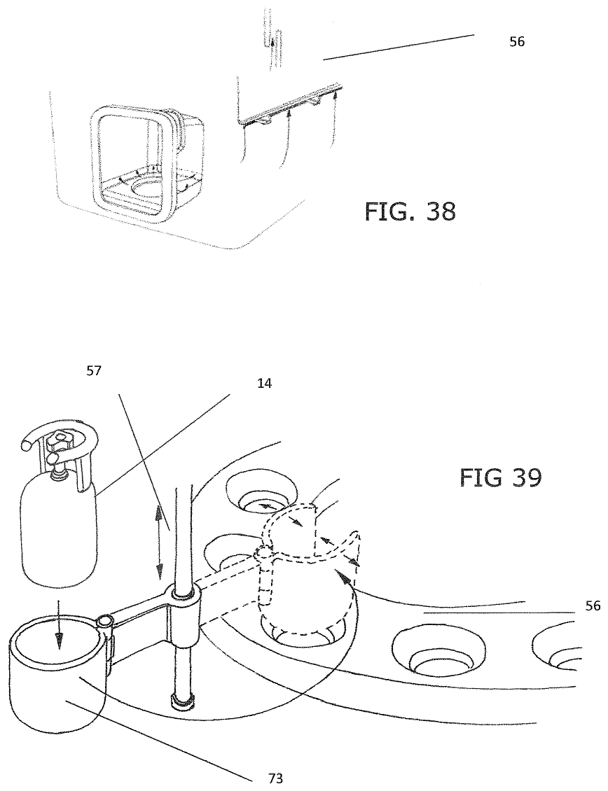

FIG. 38 shows how an airflow system 56 can be introduced to the housing to remove propane gas.

FIG. 39 shows an alternative embodiment, a pivoting tank holder with open arms 73, a 20 pound or 30 pound tank 14 and a posts 57 that rotates the tank holder to move tanks in and out of the main enclosure of the dispensing system.

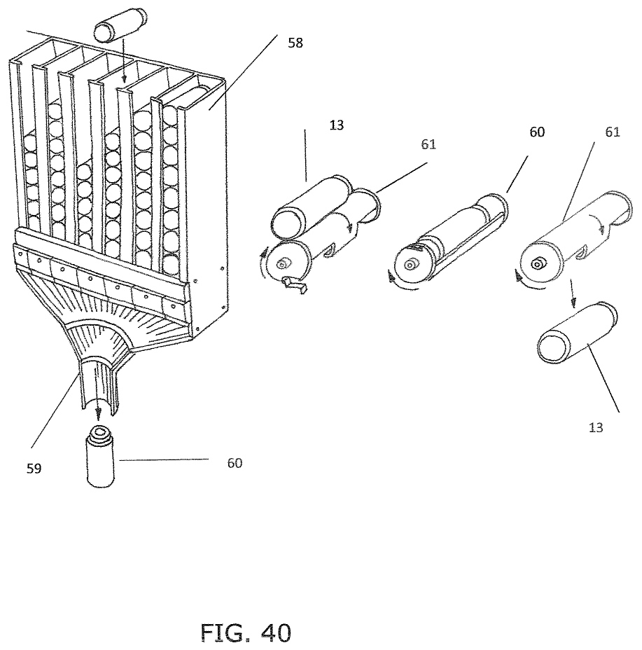

FIG. 40 is a storage and dispensing device 58 for 16 oz. user propane tank system. The Chute 59 delivers 16 oz. user propane tank 13 to the user. The 16 oz.e system utilizes the 16 oz. tank carrier plus the 16 oz. user tank 60, the carrier alone 61 is also shown.

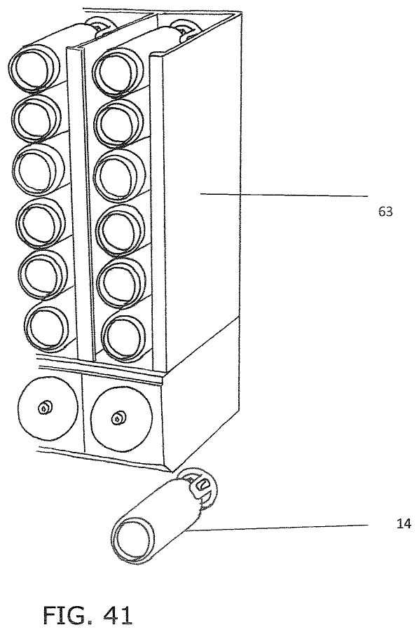

FIG. 41 is retail storage 63 for 20 lb. or 30 lb. 14 user propane tanks.

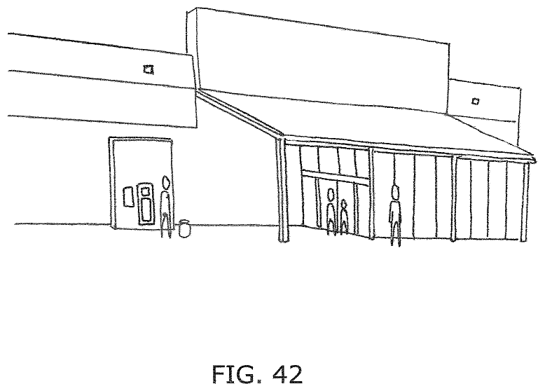

FIG. 42 is a retail setting for the housing and system, everything is within a building.

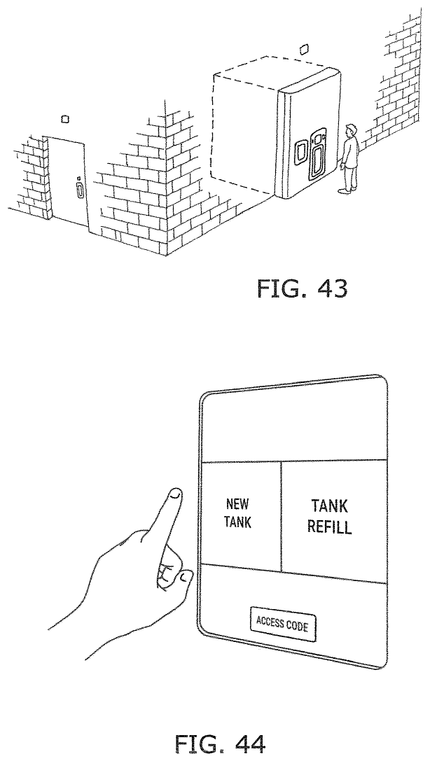

FIG. 43 shows the housing and dispensing system inside of a building.

FIG. 44 shows an opening screen where the customer is paying on-site.

FIG. 45 shows how the customer selects what size tank they want.

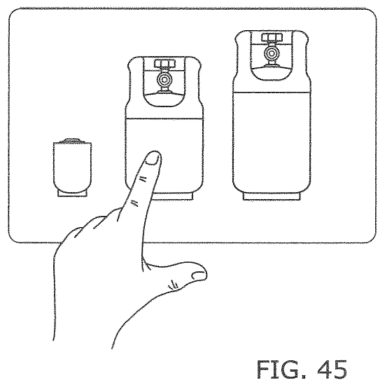

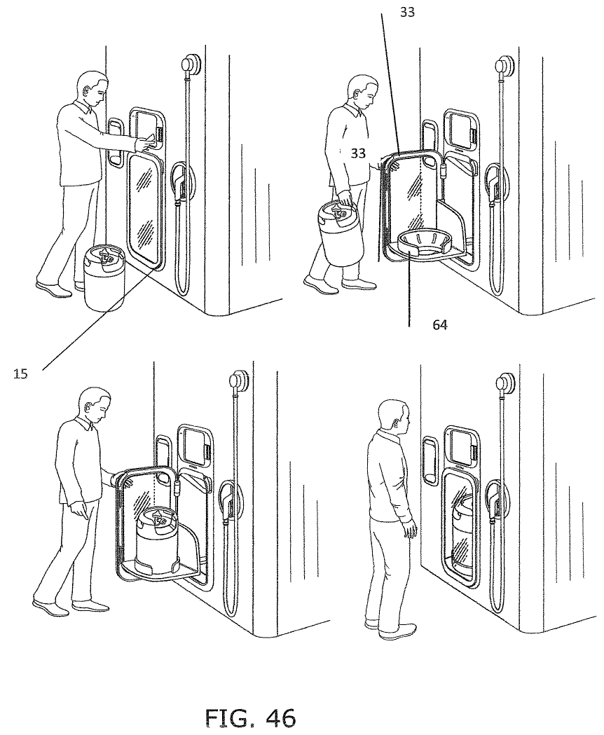

FIG. 46 shows the customer using the access door 15 to inset the user propane tank 14 for filling. The figure also shows the concealed handle 33 and the access door user propane tank holder 64.

FIG. 47 shows the autofill dispensing nozzle 66, which is connected to the fill line (not shown) prior to being inserted into the autofill valve 67. Also shown is the user propane tank autofill valve 65.

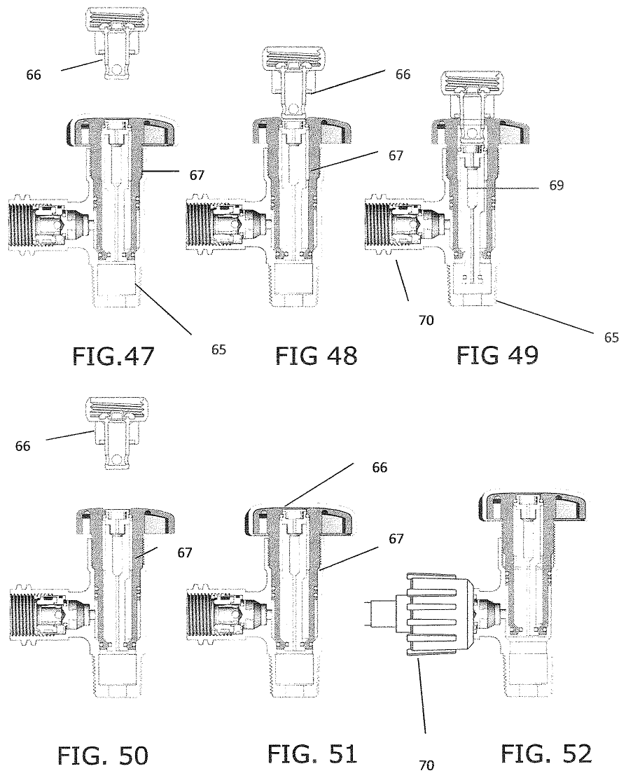

FIG. 48 shows the autofill dispensing nozzle 66 starting to be inserted into the autofill valve 67.

FIG. 49 shows the autofill nozzle fully inserted, but still with a section abode the autofill valve, and the part 69 that opens the flow to the user propane tank depressed and connected to the user propane tank's autofill valve 65.

FIG. 50 to FIG. 51 shows an alternative configuration where the autofill nozzle 66 is inserted completely into the autofill valve 67.

FIG. 52 shows the coupling connection 70 to the user propane tank.

I claim:

1. A Dispensing System for Filling and Refilling Propane Containers comprising:
Setting up an account;
customer would download an app, create an account, adding a login, password, two-step authentication and payment information;
Purchasing;
when a user propane tank is filled, a confirmation code is emailed or texted to customer, these steps may also be completed at a built-in display at a dispensing location. All tanks have an RFID # for identification and also to ensure that the user propane tank is properly filled by a autofill dispenser;
Setting Up Dispensing System at Dispensing Locations;
Utilizing a self-contained main enclosure to hold all components comprising;
a structural frame;
dispensing tanks with storage within the main enclosure, distribution tank has bottom flange connecting attachments fill lines, regulator, valves and sits on a distribution tank pedestal;
measuring and communication equipment incorporated into the dispensing tank;
a storage location within a main enclosure for multiple new user propane tanks;
placement apparatus for placing the user propane tank accessible to users;
a user propane tank moving system;
an access door covering the entry point of the placement apparatus;
a robotic picker system that places the users propane storage tanks in position to be filled and removes the user propane storage tank after it is filled to a user tank movement system;
automatic filling of the user propane tanks, with a with a dispenser tank with dispensing connection that automatically connects to the user propane tank;
an exit location where user propane storage tanks can be released once filled; secure storage device that will release one user propane tank at a time;
an access door covering the exit point of the placement apparatus;
an autofill nozzle for cases where it is not practical to insert a user propane tank into the automated system, such as with some RV applications, the autofill nozzle, autofill valve are also available on the distribution tank and the amount dispensed is incorporated into the billing;
wherein the user simply put a user propane tank, new or used, into a fixed placement apparatus inside the entry door, closes the door and pushes the start button and retrieves a tank from the exit location;
a code entry system for people who purchase with their cell phone; and a payment system, which also can issue codes, located at the main enclosure for refilling tanks and includes a credit card reader system;
a control system, which may be one or more controllers, the control system consisting of a start button, moving the user propane tank placement apparatus to a location where a robotic picker can pick up the user storage device, a sensor device that notifies the dispenser that the user propane tank is in the proper position, activates the user propane tank device filling procedure, measures the amount of propane dispensed, disconnects the user propane tank dispenser system, activates the user propane tank movement system to move the user propane tank to the exit position, which once the user propane tank reaches that position activates an signal for the user to take the user propane tank away, and the control system then calculates a billing amount, prepares an invoice and sends it to the card reader or a central payment processing site.

2. The purchasing system of claim 1 where the purchasing is completed by users purchase a user propane tank online or at a retail location and then go to dispensing station to fill the tank.

3. The purchasing system of claim 1 where the purchasing is completed by users downloading an app, making the purchase online, receiving a code, and then going to the dispensing station, entering the code into the display at the dispensing station and filling their tank.

4. The dispensing system of claim 1 designed for filling a single propane tank, so the user would simply put the propane tank into a fixed placement apparatus inside the door, close the door and push the start button, and then when filled open the door and remove the tank.

5. The propane tank filling apparatus of claim 1, where a tank when placed into the system goes into a carousel storage system, capable of holding up to 44 user propane tanks and the user propane tank that goes to the exit point is a tank in the storage system next in queue. Each carousel has eleven open slots to receive either a 20 lbs or 30 lbs propane tank. Carousels rotate left and right, there is no physical hub or center axis.

6. The dispensing tank of claim 1 where the dispensing tank pedestal has open area to allow motorized drawer to partially slide under distribution tank.

7. The user propane storage tank of claim 1 with an imbedded RFID tag. Each user propane tank has its own RFID enabling a tank history to be established; tank size, frequency of fill, amount of propane filled, location of fill, tank expiration.

8. The access door of claim 1 where the door consists of an opaque plastic bezel surrounding a transparent inner Plexiglas window to showcase the propane fill area. To open the access door there is a concealed door handle in the upper right-hand corner of the access door. Within the propane fill area, the autofill door opens upward.

9. The user propane tank moving system of claim 1, after filling there is a drawer slide comprised of a motorized drawer with a contoured docking area for accepting individual user propane tanks, moving back and forth along a horizontal plane to transport individual user propane tanks to the robotic picker and dispensing to customers. The drawer slide is the main access point for user propane tanks to be dispensed to customers. The drawer slide travels along a horizontal axis moving into the exit pass-through open slot in carousel levels of the propane fill station. Each carousel has eleven open slots to receive either a 20 lbs or 30 lbs propane tank. Carousels rotate left and right, there is no physical hub or center axis.

10. The placement apparatus for placing the user propane storage tank accessible to users of claim 1 holding different configuration and sizes of user tanks over the standard user propane tank base which sets into the holder in the storage system.

11. The distribution tank of claim 1 placed at a remote location away from the main enclosure rather than contained within the storage system.

12. The main enclosure of claim 1 with an air flow system that removes leaked propane gas.

13. The storage and placement system for claim 1 for user propane tanks with a rotating arm system that rotates the propane tank from the user input location to the units storage location, prior to filling. The rotating arm system may also be used to move filled tanks from the storage location to the dispensing point.

14. The user tank storage and placement system of claim 1 utilizing a horizontal storage with a directing chute that sends user propane tanks to the dispensing point upon user request.

15. The user propane tank storage and placement system of claim 1 horizontal dispensing stem where user propane tanks are gravity fed to an exit point, user propane tanks to be dispensed are on the bottom of the column of horizontal user propane tanks,

16. The main enclosure system of claim 1 located within-in a building. 17.

17. The carousel of claim 1 where the user propane tanks on the carousel are stored horizontally.

18. A side door delivery system with the main enclosure of claim 1, where the user propane tanks are stored in multiple racks, with the user tanks moved down to a lower level by a dropping mechanism in one corner.

19. A user tank delivery system of claim 1, where user propane tanks are moved from the storage location into the dispensing slot before the dispensing door, rotating the tanks through a sliding/motion created by the slide mechanism.

20. The user propane tank storage system of claim 1 with a storage systems that is customized for a certain size tank, rather than a system that can hold various sizes of tanks.

21. The user propane tank storage system of claim 1 with a two-component storage system where two storage components can be rotated when one storage component is empty.

22. The user tank storage system of claim 1 with a gravity fed storage unit that moves tanks down a series of racks to the dispensing point.
